(19) United States
(12) Patent Application Publication
(10) Pub. No.: US 2025/0202254 A1
(43) Pub. Date: Jun. 19, 2025

(54) Portable Charging Pad for Wireless Chargers

(71) Applicant: Joshua McKenzie, Kennewick, WA (US)

(72) Inventor: Joshua McKenzie, Kennewick, WA (US)

(21) Appl. No.: 18/538,374

(22) Filed: Dec. 13, 2023

(51) Int. Cl. H02J 7/00; H02J 50/10; H02J 50/40

(52) U.S. Cl. CPC H02J 7/0045; H02J 7/0013; H02J 7/0048; H02J 50/10; H02J 50/40

(57) ABSTRACT

A portable wireless charger kit includes one or more charging pads, each charging pad including an enclosure that accommodates a power storage unit that stores power, and a wireless power transmission means having a transmitter element that generates a magnetic field when excited by electrical energy supplied from the power storage unit. The kit includes a charging station for charging batteries of one or more charging pad. The charging station includes a housing that accommodates the one or more charging pads, and a set of contacts corresponding to contact pins of the one or more charging pads. The set of contacts electrically connect the charging pads to a power source when the contact pins of the charging pads come into contact with the set of contacts, thereby allowing electrical energy from the power source to be stored in the batteries of the charging pads.

The present application claims priority to the earlier filed provisional application having Ser. No. 63/534,620, and hereby incorporates subject matter of the provisional application in its entirety.

### FIELD OF THE PRESENT DISCLOSURE

The disclosure relates generally to wireless chargers. Particularly and not exclusively, the subject matter of the instant disclosure relates to the construction and configuration of a portable wireless chargers.

### BACKGROUND OF THE PRESENT DISCLOSURE

Wireless chargers enable electronic devices to be charged without requiring physical links, such as wires or cords. Wireless power transfer means used by wireless chargers often have an inductive charging pad that transmits electrical energy to a receiver in the electronic device. For instance, wireless chargers employing Qi interface standards have charging pads (also known as housing stations) that are connected to a power source for providing inductive power. Wireless chargers aim to provide portability, improve durability of electronic devices by eliminating need for plugging and unplugging physical links into ports of the electronic devices, provide increased convenience and aesthetics, and increase reliability and number of charging events when installed in conveniently accessible locations, such as in tables, furniture, and the like.

However, since charging pads are often tethered to power sources, such as to power outlets by wires or physical links, wireless chargers do not adequately address issues associated with portability of chargers. Tethering the charging pads to the power source limits the portability of the wireless charger, and the possible applications thereof, to the length of the wires. For instance, charging pads can only be configured in furniture or walls within the reach of power outlets. Wireless chargers also cannot be moved from one location to another location without disconnecting and re-connecting physical links to power sources in the respective locations. Such wireless chargers are also not suitable for outdoor applications where access to power sources is limited.

Additionally, wireless chargers require the electronic device to be placed in a predefined alignment over the charging pads for efficient charging. Furthermore, the electronic devices cannot be moved during the duration of charging, thereby preventing users from operating the electronic devices. Albeit with limited range, traditional chargers allow users to operate electronic devices so long as the device is tethered to the charger. For such uses, wireless chargers have not adequately provided portability to users.

Therefore, there is a need in the art for a portable charging pad for wireless chargers.

### SUMMARY

In order to obviate the shortcomings of the background art, a convertible carriage is provided and illustrated in the instant disclosure.

Principally, in accordance with the most preferred embodiment of the present disclosure, a charging pad may include a power storage unit having a battery for storing electrical energy, and a wireless power transmission means having a transmitter element that generates a magnetic field when excited by electrical energy supplied from the power storage unit, where the magnetic field induces an electric current at a receiver element of an electronic device, the induced electric current charging the electronic device.

In some embodiments, the charging pad may include an enclosure that accommodates the power storage unit and the wireless power transmission means inside the enclosure, wherein the enclosure has a substantially cylindrical contour.

In some embodiments, the enclosure may include an interface surface having an attachment means that securely attaches the charging pad to the electronic device.

In some embodiments, the enclosure may include an interface surface having a dimpled portion that separates the transmitter element from the receiver element of the electronic device by a predetermined distance.

In some embodiments, the power storage unit may include one or more electric contacts configured to electrically connect the battery to a power source wherefrom the battery receives and stores electrical energy.

In some embodiments, the charging pad receives power from the power source via a charging station. The charging station may include a housing that accommodates one or more of the charging pads, a set of contacts corresponding to the one or more contact pins. The corresponding set of contacts may electrically connect the charging pad to the power source when the one or more contact pins come into contact with the set of contacts.

In some embodiments, the transmitter element may be a transmitter coil that generates an oscillating magnetic field when AC may be passed therethrough.

In some embodiments, may include a charging module that modulates power supplied to the transmitter element based on charging requirements of the electronic device.

In some embodiments, may include a converter that converts Direct Current (DC) from the power storage unit to AC for consumption by the wireless power transmission means.

In some embodiments, may include one or more feedback units that indicate state of charge in the battery of the charging pad.

In another aspect, a charging station for charging batteries of one or more charging pads may include a housing that accommodates the one or more charging pads, and a set of contacts corresponding to one or more contact pins of the one or more charging pads. The set of contacts electrically may connect the charging pads to a power source when the contact pins of the charging pads come into contact with the set of contacts.

In some embodiments, the housing may be a receptacle having an open top, wherein the one or more charging pads are adjacently placed within the receptacle.

In some embodiments, the housing may include a rack having one or more resilient members that frictionally hold the one or more charging pads therebetween, and wherein the set of contacts are defined on the sidewall.

In some embodiments, the housing may include one or more slots that accommodate the one or more charging pads, wherein the set of contacts are defined within the one or more slots.

In some embodiments, the charging station may include a physical link that electrically connects the charging station to the power source.

In some embodiments, the charging station may include one or more feedback units that indicate state of charge in a battery of one or more of the charging pads.

In yet another aspect, a portable wireless charger kit may include one or more charging pads, each charging pad may include a power storage unit having a battery for storing electrical energy, and a wireless power transmission means having a transmitter element that generates a magnetic field when excited by electrical energy supplied from the power storage unit. The wireless charger kit may include a charging station for charging batteries of the one or more charging pad include, a housing that accommodates the one or more charging pads, and a set of contacts corresponding to contact pins of the one or more charging pads. The set of contacts electrically may connect the charging pads to a power source when the contact pins of the charging pads come into contact with the set of contacts.

In some embodiments, the housing of the charging station may be a receptacle having an open top, and the one or more charging pads being adjacently placed within the receptacle.

In some embodiments, the housing of the charging station may include a rack with one or more resilient members protruding out from the sidewall that frictionally hold the one or more charging pads therebetween, and the set of contacts are defined on the rack.

In some embodiments, the housing may have a substantially cuboidal profile with one or more slots that accommodate the one or more charging pads, and the set of contacts are defined within the one or more slots.

The following description is illustrative in nature and is not intended to be in any way limiting. In addition to the aforementioned illustrative aspects, embodiments, and features of the present disclosure, further aspects, embodiments and features will become apparent by reference to the following detailed description.

### BRIEF DESCRIPTION OF THE ACCOMPANYING DRAWINGS

The accompanying drawings illustrate the best mode for carrying out the disclosure as instantly contemplated and set forth hereinafter. The instant disclosure may be more clearly understood from a consideration of the following detailed description of the preferred embodiments taken in conjunction with the accompanying drawings where all figures are diagrammatic and not to scale. Further, like reference letters and numerals indicate the corresponding parts in various figures in the accompanying drawings.

FIG. 1 illustrates an exemplary view of an electronic device placed on a charging pad, according to embodiments of the present disclosure.

FIG. 2A illustrates an exemplary exploded view of the charging pad, according to embodiments of the present disclosure.

FIG. 2B illustrates an exemplary schematic circuit view of the charging pad, according to embodiments of the present disclosure.

FIG. 3A illustrates an exemplary first embodiment of a charging station, according to embodiments of the present disclosure.

FIG. 3B illustrates an exemplary second embodiment of the charging station, according to embodiments of the present disclosure.

FIG. 3C illustrates an exemplary third embodiment of the charging station, according to embodiments of the present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the present disclosure as set forth.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

Reference throughout this specification to “some embodiments” or “other embodiments” or “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, “substantially” means largely or considerably, but not necessarily wholly, or sufficiently to work for the intended purpose. The term “substantially” thus allows for minor, insignificant variations from an absolute or perfect state, dimension, measurement, result, or the like as would be expected by a person of ordinary skill in the art, but that do not appreciably affect overall performance.

As used herein, “about” means approximately or nearly, and in the context of a numerical value or range set forth means±10% of the numeric value.

Throughout the present disclosure, “attachment means” include, but are not be limited to, screws, nails, rivets, adhesives, magnets, hook and loop fasteners, hook and slot fasteners, interlocking elements, friction-grip releasable fasteners, fastening straps, and the like.

Typically, a wireless charger has a charging pad that requires physical connections to a power source. Electronic devices are placed on the charging pad for charging. Physical links, such as wires or cords, are often tethered to the charging pads, thereby limiting the portability of wireless chargers to the length of said physical links. The length of the physical links serves as a limitation for potential use cases for wireless chargers. Further, such tethering requirements also make wireless chargers unsuitable for applications where access to power sources is limited, such as in outdoor environments or travel. Therefore, there is a need for wireless chargers with charging pads that are portable.

Accordingly, in order to overcome at least the above-mentioned drawbacks associated with the existing wireless chargers, embodiments of portable charging pads are proposed. Some of the characteristics of the proposed charging pads include portability, increased durability due to minimized use of removable plugs, and simple construction and design for convenient use. The proposed embodiments of the charging pad address the above-mentioned deficiencies of the existing wireless chargers by using a portable charging pad that stores power in a power storage unit, and transmits the stored power to electronic devices for charging when the electronic devices are placed on the charging pads, for example, thereby eliminating the need for tethering the charging pads to the power source. The portable charging pads may be periodically placed on a charging station which may restore power to said charging pads.

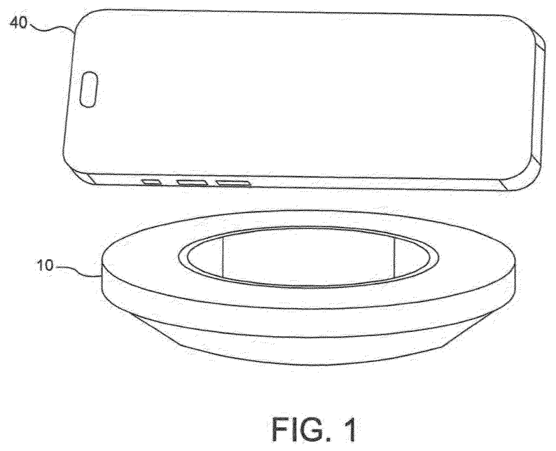

FIG. 1 illustrates an exemplary view of an electronic device 40 placed on a charging pad 10, according to embodiments of the present disclosure.

The charging pad 10 may be used for charging the electronic device 40. In some embodiments, the electronic device 40 may be placed over the charging pad 10. The electronic device 40 may be any one of including, but not limited to, smartphones, toothbrushes, implantable biomedical devices such as pacemakers, Radio-frequency identification (RFID) tags, induction cookers, heaters and other appliances, Internet-of-Things (IoT) devices, watches, handheld devices, and the like.

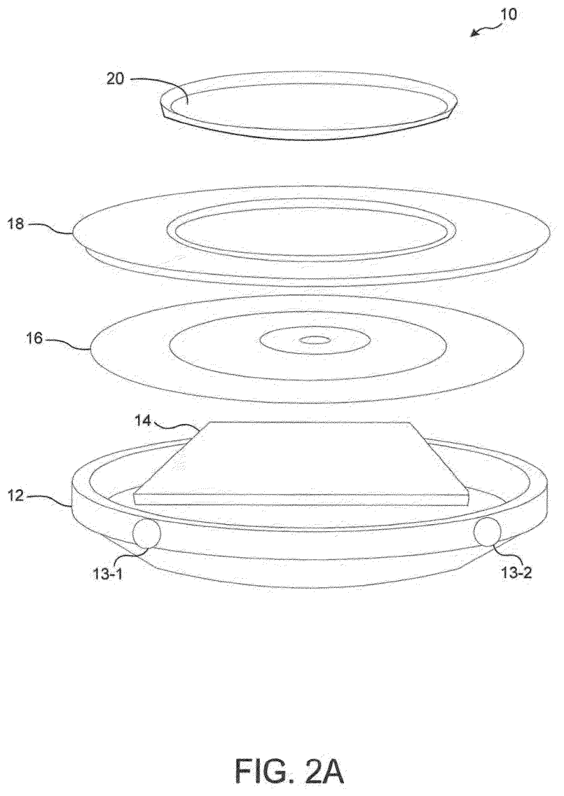

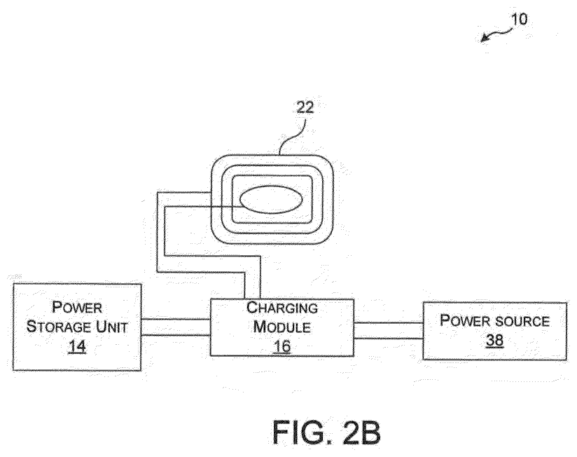

In some embodiments, the charging pad 10 may include a wireless power transmission means, as shown in FIGS. 2A and 2B, for wirelessly charging the electronic device 40. The wireless power transmission means may be any one of including, but not limited to, resonant inductive coupling, capacitive coupling, electrodynamic wireless power transfer, and the like, for wirelessly transmitting electrical energy to the electronic device 40. In some embodiments, the wireless power transmission means may use inductive coupling means complaint with Qi interface standards for charging the electronic device 40.

In some embodiments, the charging pad 10 may include a transmitter element for transmitting electrical energy to the electronic device 40. In some embodiments, the transmitter element may be indicative of a transmitter coil 22, as shown in FIG. 2B. The electronic device 40 may include corresponding receiver elements for receiving the electrical energy. The transmitter coil 22 may be configured to generate an oscillating magnetic field when a current is passed therethrough. The oscillating magnetic field may interact with the receiver elements of the electronic device 40, thereby inducing the receiver elements to generate an electric current. The induced electric current may be supplied to the electronic device 40 for charging. In some embodiments, the electronic device 40 may use the induced electric current for charging a corresponding battery, such as that of a laptop. In other embodiments, the electronic device 40 may consume the induced electric current as and when generated, such as for operating the laptop when the battery thereof is fully charged.

FIG. 2A illustrates an exemplary exploded view of the charging pad 10, according to embodiments of the present disclosure. As shown, the charging pad 10 may include an enclosure 12, a power storage unit 14 one or more contact pins 13-1 and 13-2 (collectively referred to as contact pins 13), a charging module 16, and an interface surface 18.

In some embodiments, the power storage unit 14 may store power in the form of electrical energy. The power storage unit 14 may have a battery for chemically storing the electrical energy therein. In some embodiments, the power storage unit 14 may include more than one batteries. In some embodiments, the battery may be any one or combination batteries made of including, but not limited to, lithium-ion (e.g., lithium iron phosphate, lithium cobalt oxide, other lithium metal oxides, etc.), lithium-ion polymer, nickel metal hydride, nickel cadmium, nickel hydrogen, nickel-zinc, silver zinc, and the like. The stored electrical energy may be transmitted to the electronic device 40 by the charging pad 10. In some examples, the battery may be a rechargeable battery. In other examples, the battery may be a disposable battery. In such examples, the disposable battery may be slotted into, and replaced from the charging pad 10. The disposable battery may be periodically replaced on consuming the electrical energy stored therein.

In some embodiments, the battery may have a storage capacity between about 3000 milli-ampere-hour (mAh) to about 5000 mAh. However, batteries with other storage capacities may be selected based on the form factor and design requirements of the charging pad 10. The power storage unit 14 may provide the charging pad 10 with power for charging the electronic device 40, thereby eliminating the need for being tethered to a power source 38 via a physical link and allowing the charging pad 10 to be portable. The charging pad 10 may be placed on any suitable surface for supporting and charging the electronic device 40, without being limited to the length of the physical link.

In some embodiments, the contact pins 13 may be connected to the battery of the power storage unit 14. In some embodiments, contact pin 13 may allow current to pass through the battery. In some embodiments, the contact pins 13 may be configured to the terminals of the battery. In other embodiments, the contact pins 13 may be configured to the terminals of the battery by a set of wires.

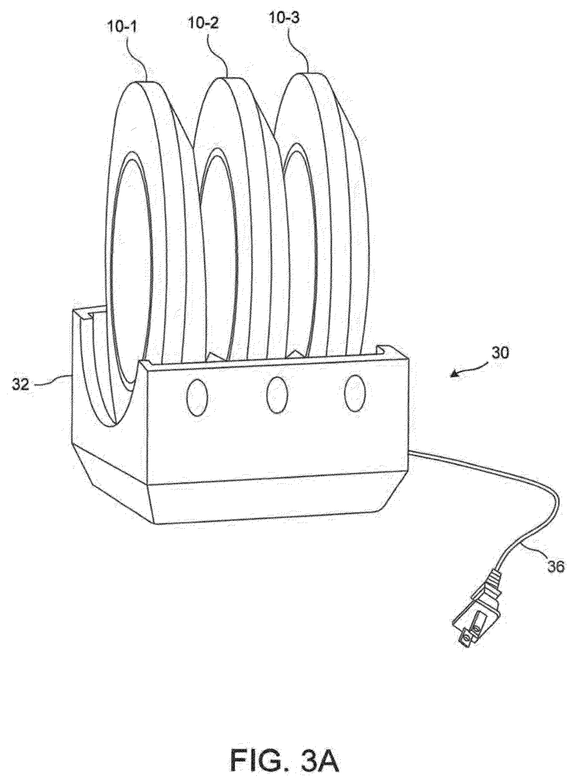

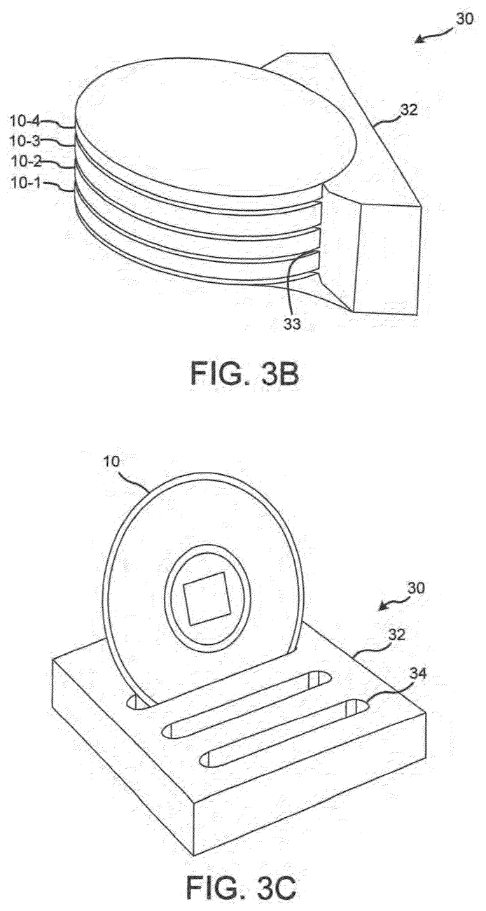

In some embodiments, the contact pins 13 may be exposed to from the enclosure 12. In some embodiments, a charging station 30 (as shown in FIG. 3A-3C) may include a corresponding set of contacts (not shown). The contact pins 13 may be caused to come into contact with the corresponding set of contacts whereby the contact pins 13 may be electrically connected to the power source 38. The charging station 30 may be configured to receive power from the power source 38. In some embodiments, the power source 38 may be any one or combination of including, but not limited to, power outlets, solar power generators, thermoelectric generators, piezoelectric generators, fuel cells, flywheels, and the like. The charging station 30 may provide power to one or more of the charging pads 10 via the corresponding contact pins 13. The contact pins 13 and the set of contacts may be made of electrically conductive materials, such as copper. The electrical energy from the power source 38 may be receive by the charging pads 10 through the contact pins 13, and may be stored in the battery thereof.

In some embodiments, the enclosure 12 may have a substantially circular contour. In such embodiments, the transmitter coil 22 may have a substantially spiral contour. In other embodiments, the enclosure 12 may have a substantially rectangular contour. In such embodiments, the dimensions of the charging pad 10 may correspond to the dimensions of the electronic device. In some examples, the enclosure 12 having a cuboidal geometric profile may be attached to the electronic device 40 indicative of a smartphone such that the contours of the charging pad 10 are integrated within the boundaries of the electronic device 40, optimizing the overall space utilization. In other embodiments, the enclosure 12 may have a polygonal contour suitably adapted to accommodate the geometric profiles of one or more of the electronic devices 40 for which the charging pad 10 may be intended.

In some embodiments, the enclosure 12 may have a substantially cylindrical profile. In such embodiments, the enclosure 12 may have a diameter of about 3″, and a thickness of about 0.5″. In other embodiments, the enclosure 12 may be suitably contoured and dimensioned to correspond to the electronic device 40 for which the charging pad 10 may be intended. The enclosure 12 may accommodate the power storage unit 14 and the charging module 16 therein. The geometric profile of the enclosure 12 may be suitably adapted based on the dimensions of the charging module 16 and the power storage unit 14 accommodated therein.

In some embodiments, the interface surface 18 may be indicative of a top surface of the enclosure 12. In some embodiments, the interface surface 18 may engage with the surface of the electronic device 40. In some embodiments, the interface surface 18 may include one or more abutments (not shown). The one or more abutments may receive and secure the electronic device 40 to the charging pad 10. The one or more abutments may allow the receiver element of the electronic device 40 to be aligned with the transmitter element of the charging pad 10 when the electronic device 40 is placed on the changing pad 10. The one or more abutments may be contoured and arranged to accommodate electronic devices 40 of a plurality of shapes, sizes and functions.

In some embodiments, the interface surface 18 may include an attachment means for attaching the charging pad 10 to the electronic device 40. In some embodiments, the attachment means may include a male interlocking element may fit into a female interlocking element on the charging pad 10 and the electronic device 40 respectively, or vice versa. In some embodiments, the male interlocking element may be either interference fitted, transition fitted or clearance fitted into the female interlocking element. In some embodiments, the charging pad 10 may have anti-slip surfaces made of including, but not limited to, rubber, silicone, malleable gel, and the like. In some embodiments, the anti-slip surfaces may have textured patterns to maximize friction with the electronic device 40.

In some embodiments, the interface surface 18 may include magnets that may securely attach the charging pad 10 to the electronic device 40. The magnets may hold the charging pad 10 securely to the electronic device 40, ensuring a reliable charging connection. In such embodiments, the magnets may be configured to secure the charging pad 10 to the electronic device 40 in the desired alignment that maximizes efficiency of power transfer.

In some embodiments, the interface surface 18 may have a dimpled portion 20. In some embodiments, the dimpled portion 20 may support the electronic device 40 in proximity to the charging module 16. The dimpled portion 20 may minimize contact area between the electronic device 40 and the charging pad 10. By minimizing the contact area, the charging pad 10 may allow for dissipation of heat generated during charging. The dimpled portion 20 may allow users to conveniently grip and separate the electronic device 40 from the charging pad 10. In some embodiments, the transmitter element may be placed below the dimpled portion 20 of the charging pad 10 to allow the transmitter element to be separated by a predetermined distance from the receiver element of the electronic device. The predetermined distance may be selected to maximize efficiency of energy transfer between the charging pad 10 and the electronic device 40.

FIG. 2B illustrates an exemplary schematic circuit view of the charging pad 10, according to embodiments of the present disclosure.

The charging module 16 may be disposed inside the enclosure 12. The charging module 16 may be configured to be between the power storage unit 14 and the electronic device 40 during charging. The charging module 16 may be electrically connected to the power storage unit 14. In some embodiments, the charging module 16 may include the transmitter element of the charging pad 10. In some embodiments, the charging module 16 may be implemented on a printed circuit board. In some embodiments, the charging module 16 may also include a converter configured to convert Direct Current (DC) from the battery to Alternating Current (AC), and pass the AC current to the transmitter element. In some embodiments, the charging module 16 may be implemented on printed circuit boards, but may not be limited thereto. In some embodiments, the converter may also be configured to convert AC received from the power source 38 to DC for charging and restoring electrical energy in the batteries of the charging pad 10.

In some embodiments, the transmitter element may be indicative of the transmitter coil 22. In some embodiments, the transmitter coil 22 may be a single induction coil having a plurality of turns. In other embodiments, the transmitter element may include a plurality of coils arranged below the dimpled portion of the interface surface 18. In such embodiment, the plurality of coils may allow for free positioning of the electronic device 40 on the interface surface 18. The number of turns and layers associated with the transmitter element may be suitably adapted based on the charging requirements of the electronic device 40. In some embodiments, each turn of the transmitter element may have a substantially circular contour. In other embodiments, each turn of the transmitter element may have a substantially polygonal contour that correspond to the contours of the enclosure 12. In some embodiments, the transmitter element may be resonantly coupled with the receiver element.

When power is supplied from the power storage unit 14 through the charging module 16, the transmitter coil 22 may generate a magnetic field. The charging module 16 may be configured to controllably modulate the power supplied to the transmitter coil 22. In some embodiments, the charging module 16 may modulate the power supplied to the transmitter coil 22 such that the transmitter coil 22 generates oscillating magnetic fields. The oscillating magnetic fields may induce an electric current in the receiver element of the electronic device 40. The receiver element may be indicative of a receiver coil (not shown). The receiver coil may be connected to a power receiver disposed within the electronic device 40. In some embodiments, the power receiver may be indicative of power storage units, such as corresponding batteries, of the electronic device 40. In other embodiments, the power receiver may be a component, such as a processor or a fan, of the electronic device 40 that consumes the induced electric current received from the charging pads 10. The charging module 16 may controllably modulate the power supplied to the transmitter coil 22 based on the charging requirements of the electronic device 40.

In some examples, the charging pad 10 may be supported on a table. The electronic device 40, such as a smartphone as shown in FIG. 1, may be placed on the electronic device 40 for charging. In such examples, the transmitter element of the charging pad 10 and the receiver element of the electronic device 40 may be aligned to enable the magnetic field generated by the transmitter element to induce a voltage in the receiver element. In other examples where the electronic device 40 is indicative of a biomedical implant such as pacemakers, the charging pad 10 may be placed proximately to the biomedical implant. In such examples, a patient having said biomedical implant may hold the charging pad 10 in proximity to the implant for charging. Further, the charging pad 10 may be supported on proximately to the location of the implant by means including, but not limited to, adhesives, straps, tapes, and the like, in proximity to the biomedical implant for the duration of charge. Since the charging pad 10 eliminates the need for tethering, the charging pad 10 may be suitable for applications where power sources are inaccessible, such as in outdoor environments. In an example, one or more of the charging pads 10 may be carried outdoors, such as to including, but not limited to, beaches, campsites, picnic and tourist areas, farmlands, forests, lakeshores, and the like, for charging the electronic device 40. Further, since the charging pad 10 is powered by the power storage unit 14, the wireless charger need not be tethered to the power source 38 during the duration of charging.

In other embodiments, the charging pad 10 may be removably embedded into hardware appliances or artefacts. In an example, the charging pad 10 may be removably embedded into a table or an armrest of a furniture. In such examples, the electronic device indicative of a laptop may be charged during ordinary use when placed on such tables.

In some embodiments, the charging pads 10 may include one or more feedback units to indicate to the user the state of charge in each of the charging pads 10. In some embodiments, the feedback units may be any one or combination of Light Emitting Diode (LED) lights, display monitors, and speakers, but not limited to the likes.

In some embodiments, the charging station 30 may be configured to provide electrical energy to one or more of the charging pads 10. In some embodiments, the charging station 30 may charge the batteries of the charging pads 10. The charging station 30 may include the corresponding set of contacts that engage with the contact pins 13 of the charging pads 10. The charging pads 10 may receive the electrical energy from the power source 38 connected to the charging station 30 through the corresponding set of contacts. In some examples, once a user exhausts the power stored in the power storage unit 14 of the charging pad 10, the user may place the charging pad 10 in the charging station 30 to restore power in the power storage unit 14.

FIGS. 3A-3C illustrate various embodiments of the charging station 30. The charging station 30 may include a housing 32 that accommodates one or more of the charging pads 10. In some embodiments, the housing 32 may charge one or more of the charging pads 10 simultaneously. The form factor of the housing 32 may be suitably adapted based on the form factor of the charging pads 10. In embodiments where the charging pads 10 have a substantially cylindrical profile, interior surfaces of the housing 32 may have curved contours to accommodate lateral surfaces of the charging pads 10. In embodiments where the charging pads 10 have a substantially cuboidal profile, the interior surface of the housing 32 may have linear contours. In some embodiments, the housing 32 may include one or more feedback units to indicate to the user the state of charge in each of the charging pads 10. In some embodiments, the feedback units may be any one or combination of LED lights, display monitors, and speakers, but not limited to the like.

FIG. 3A illustrates an exemplary first embodiment of the charging station 30 for the charging pad 10, according to embodiments of the present disclosure.

The charging station 30 may include the housing 32 for accommodating one or more of the charging pads 10. As shown in FIG. 3A, the housing 32 may be a receptacle having an open top. The charging pads 10, such as the charging pads 10-1, 10-2, 10-3, may be adjacently placed within the receptacle. The housing 32 may have the set of contacts defined therein. The set of contacts may be configured to engage with the one or more contact pins 13 of the charging pads 10-1, 10-2, 10-3. In some embodiments, the housing 32 may be connected to the power source 38 by a physical link, such as a wire 36. The wire 36 may be plugged into a power outlet to provide the charging station 30 with power. In some embodiments, the wires 36 may have Universal Serial Bus (USB) Type B, or USB Type C connectors, and may be plugged into the power source 38 for receiving electrical power. In such embodiments, the charging station 30 may be connected to any power source 38 having corresponding USB ports. The power provided by the charging station 30 may be stored in the power storage unit 14 of the charging pads 10.

FIG. 3B illustrates an exemplary second embodiment of the charging station 30, according to embodiments of the present disclosure. In such embodiments, the housing 32 of the charging station 30 may include a rack 33 to accommodate the one or more of the charging pads 10 in a substantially horizontal orientation with respect to the ground. The set of contacts may be defined on the rack 33. The rack 33 may include one or more resilient members protruding out therefrom. The one or more resilient members may reversibly bend to accommodate and frictionally hold one or more of the charging pads 10 therebetween. In such embodiments, one or more of the charging pads 10, such as the charging pads 10-1, 10-2, 10-3, and 10-4, may be stacked one over the other.

FIG. 3C illustrates an exemplary third embodiment of the charging station 30, according to embodiments of the present disclosure. In such embodiments, the housing 32 of the charging station 30 may include one or more slots 34. The housing 32 may have a substantially cuboidal profile. In some embodiments, one or more slots 34 may be arranged equidistantly from each other. The one or more slots 34 may accommodate one or more of the charging pads 10. In some embodiments, the slots 34 may have the set of contacts defined therein. The charging pads 10 may be placed into the slots such that the one or more contact pins 13 engage with the set of contacts, thereby allowing the charging pads 10 to be supplied with power.

In some aspects of the present disclosure, a portable wireless charger kit may include one or more of the charging pads 10, and the charging station 30. A user may use the charging pads 10 for charging their electronic devices 40. Since the charging pads 10 are wireless, the charging pads 10 may be attached to a portion of the electronic device 40 having the receiver element. The charging pad 10 may supply electrical energy to the electronic device 40, which may either store the electrical energy in power storage units/batteries thereof or consume the electrical energy received from the charging pads 10. When the electrical energy stored in the charging pads 10 deplete, the charging pads 10 may be placed in the charging station 30. The charging station 30 may restore the depleted electrical energy in the charging pads 10. The charging station 30 may be configured to receive electrical energy from the power source 38, and supply the power to the charging pads. The user may use the second charging pad 10-2 when the first charging pad 10-1 is being charged in the charging station 30.

The instant disclosure provides a portable charging pad for wireless chargers. The charging pad may store electrical energy on a power storage unit and may transfer the stored power to electronic devices placed on said charging pad. By storing electrical energy in the power storage unit, the charging pad eliminates the need for physical links for receiving power, thereby enabling enhanced convenience and portability. The charging pads may be periodically recharged on charging stations to restore electrical energy to the charging pads. The disclosed embodiments of the portable charging pads may be adapted for different electronic devices, and may be embedded into commonly used appliances or artefacts for enabling convenient charging in the proximity of said appliances or artefacts. The charging pad simplifies and enhances a user's charging experience by providing greater convenience.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

What is claimed is:

1. A charging pad, comprising:
a power storage unit having a battery for storing electrical energy; and
a wireless power transmission means having a transmitter element that generates a magnetic field when excited by electrical energy supplied from the power storage unit, wherein the magnetic field induces an electric current at a receiver element of an electronic device, induced electric current charging the electronic device.

2. The charging pad of claim 1, comprising an enclosure that accommodates the power storage unit and the wireless power transmission means inside the enclosure, wherein the enclosure has a substantially cylindrical contour.

3. The charging pad of claim 2, wherein the enclosure comprises an interface surface having an attachment means that securely attaches the charging pad to the electronic device.

4. The charging pad of claim 2, wherein enclosure comprises an interface surface having a dimpled portion that separates the transmitter element from the receiver element of the electronic device by a predetermined distance.

5. The charging pad of claim 1, wherein the power storage unit comprises one or more electric contacts configured to electrically connect the battery to a power source wherefrom the battery receives and stores electrical energy.

6. The charging pad of claim 5, wherein the charging pad receives power from the power source via a charging station, the charging station comprising:
a housing that accommodates one or more of the charging pads; and
a set of contacts corresponding to the one or more contact pins, wherein the corresponding set of contacts electrically connects the charging pad to the power source when the one or more contact pins come into contact with the set of contacts.

7. The charging pad of claim 1, wherein the transmitter element is a transmitter coil that generates an oscillating magnetic field when Alternating Current (AC) is passed therethrough.

8. The charging pad of claim 1, comprising a charging module that modulates power supplied to the transmitter element based on charging requirements of the electronic device.

9. The charging pad of claim 1, comprising a converter that converts Direct Current (DC) from the power storage unit to AC for consumption by the wireless power transmission means.

10. The charging pad of claim 1, comprising one or more feedback units that indicate state of charge in the battery of the charging pad.

11. A charging station for charging batteries of one or more charging pad, comprising:
a housing that accommodates the one or more charging pads; and
a set of contacts corresponding to one or more contact pins of the one or more charging pads, wherein the set of contacts electrically connect the charging pads to a power source when the contact pins of the charging pads come into contact with the set of contacts.

12. The charging station of claim 11, wherein the housing is a receptacle having an open top, wherein the one or more charging pads are adjacently placed within the receptacle.

13. The charging station of claim 11, wherein the housing comprises a rack having one or more resilient members that frictionally hold the one or more charging pads therebetween, and wherein the set of contacts are defined on the sidewall.

14. The charging station of claim 11, wherein the housing includes one or more slots that accommodate the one or more charging pads, wherein the set of contacts are defined within the one or more slots.

15. The charging station of claim 11, comprising a physical link that electrically connects the charging station to the power source.

16. The charging station of claim 11, comprising one or more feedback units that indicate state of charge in a battery of one or more of the charging pads.

17. A portable wireless charger kit, comprising:
one or more charging pads, each charging pad comprising:
a power storage unit having a battery for storing electrical energy; and
a wireless power transmission means having a transmitter element that generates a magnetic field when excited by electrical energy supplied from the power storage unit; and
a charging station for charging batteries of one or more charging pad comprising:
a housing that accommodates the one or more charging pads; and
a set of contacts corresponding to contact pins of the one or more charging pads, wherein the set of contacts electrically connect the charging pads to a power source when the contact pins of the charging pads come into contact with the set of contacts.

18. The portable wireless charger kit of claim 17, wherein the housing of the charging station is a receptacle having an open top, and the one or more charging pads being adjacently placed within the receptacle.

19. The portable wireless charger kit of claim 17, wherein the housing of the charging station comprises a rack with one or more resilient members protruding out from the sidewall that frictionally hold the one or more charging pads therebetween, and the set of contacts are defined on the rack.

20. The portable wireless charger kit of claim 17, wherein the housing has a substantially cuboidal profile with one or more slots that accommodate the one or more charging pads, and the set of contacts are defined within the one or more slots.
